(19) United States
(12) Patent Application Publication
(10) Pub. No.: US 2019/0202149 A1
(43) Pub. Date: Jul. 4, 2019

(54) Tire Screw - The Simple Flat Fix

(71) Applicants: Jeffrey Boutwell Brunson, Talladega, AL (US); Brandon Paul Dill, Birmingham, AL (US)

(72) Inventors: Jeffrey Boutwell Brunson, Talladega, AL (US); Brandon Paul Dill, Birmingham, AL (US)

(21) Appl. No.: 15/862,549

(22) Filed: Jan. 4, 2018

(51) Int. Cl. B29C 73/08; F16B 35/06

(52) U.S. Cl. CPC B29C 73/08; B29L 2030/00; F16B 35/06

(57) ABSTRACT

The invention is an apparatus used to fill a tire tread puncture hole. The device simply screws into the tread puncture hole with insertion key to block air leakage. Once the invention is properly inserted, the tire may be refilled with air and get back on the road.

### CROSS REFERENCE TO RELATED APPLICATIONS

THIS IS THE FIRST APPLICATION FOR PRODUCT PATENT

### BACKGROUND OF THE INVENTION

### a. Description of the Field of the Endeavor of Invention

I. B29C 73/08 Apparatus therefor, e.g. for inserting
II. B29 C 73/00 Repairing of articles made from plastics or substances in a plastic state, e.g. of articles shaped or produced by using techniques covered by this subclass or subclass B29D (retreading tires B29D 30/54; {linings for tires acting locally B60C5/145;} devices for covering leaks in pipes or hoses F16L 55/16)

### b. Problem the Invention is Designed to Address as Well as What Makes it Different from Similar Inventions

Tire Screw-The Simple Flat Fix, is unique, as opposed to “plugging” a punctured tubeless vehicle tire, which requires the tire to be taken off and plugged by a trained professional, Tire Screw-The Simple Flat Fix is easy to use and does not require the tire to be taken off of the vehicle. Other tire repair devices that spray polymers into the tire, via the tire's air valve, can create a gooey mess and take several minutes to cure. Tire Screw-The Simple Flat Fix is designed to allow a driver to mend a tubeless tire puncture inexpensively, quickly, with no mess, and with minimal effort; no special training or tools required.

### SUMMARY OF THE INVENTION

When a vehicular tubeless tire acquires a puncture, causing air to escape, Tire Screw-The Simple Flat Fix, provides a simple repair. First, if any debris exists, remove from the puncture site by hand (if safe) or with pliers. Next, apply provided adhesive to Tire Screw's shaft. Now Tire Screw can be screwed into the puncture site using the Tire Screw Key with four to five clockwise rotations. The tire may now be inflated; driver is ready to return to the road. No need to drive with a leaking tire to the repair shop for a plug, hoping you will arrive before your tire goes completely flat. No messy clean up from polymer goop.

### DETAILED DESCRIPTION OF THE INVENTION

Parts: Screw, Key, Adhesive or Lubricant

Screw:
1. Head with ⅜″ diameter circumference with female insertion drive which will marry key's male cuts, when key is inserted to drive screw into tire puncture site.
2. Shaft with course threaded rivets, which tapers from ¼″ circumference below head of screw, down to ⅛″ circumference at bottom of shaft, proximal to tip end.
3. Tip-narrow insertion angled bottom of screw, first section to be inserted into puncture hole.

Key: whose male cuts are designed to fit into screw female insertion rivets of screw head.

The first step in the Tire Screw-The Simple Flat Fix process is coating the screw shaft with either adhesive or lubricant.

Only for use in the repair of a tire puncture hole in the tread of the tire. DO NOT USE ON TIRE PUNCTURE HOLE ON SIDE WALL OF TIRE. Tire puncture hole should not be ¼″ or larger in diameter. Ideally, screw will fill puncture equal to or less than the circumference diameter of an 8D Penny Nail (0.131″ diameter) to a 16D Penny Nail (0.162″ diameter).

Once tip of screw is placed straight in tire puncture, insert the male key cuts of the key, into the screw heads female insertion drive.

Manually grasping the bow of the insertion key, rotate key, therefore rotating screw, clockwise until all screw tip and shaft is descended into the tire surface.

A power tool should not be used to insert screw as the force may drive the screw further into puncture than necessary.

The 1/16″ head of the screw should rest horizontally flush with the tire tread. Again, no threading, shaft, or tip of screw should be visible.

Tire may now be inflated and is prepared for vehicular travel.

### DRAWINGS

Provided on additional pdf

### DESCRIPTION OF DRAWINGS

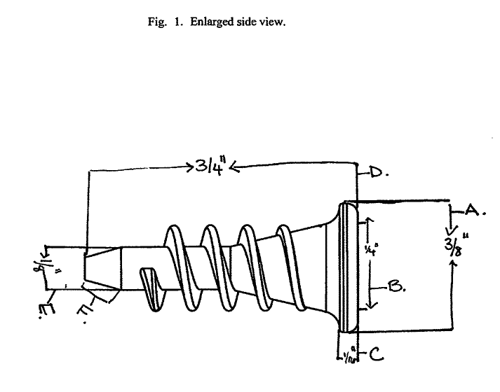

FIG. 1. Enlarged screw insertion piece side perspective view.

A. ⅜″ represents the diameter width of the screw head.

B. ¼″ represents the widest diameter width of the screw shaft circumference.

C. ⅙″ represents the width of the screw head.

D. ¾″ indicates the entire length of the screw, inclusive of tip, shaft, and head.

E. ⅛″ represents smallest width of shaft, prior to angled insertion tip segment.

F. Represents angled insertion tip at bottom end of insertion piece.

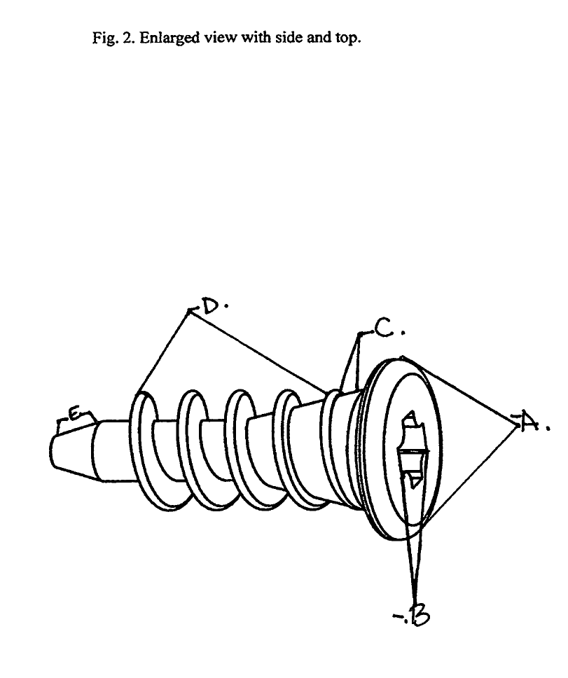

FIG. 2. Enlarged top and side perspective view of Tire Screw-screw insertion piece.

A. Head

B. Unique Female Insertion Drive

C. Shaft

D. Thread

E. Angled Tip

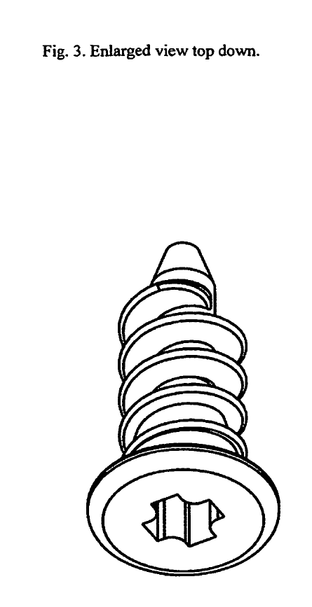

FIG. 3. Enlarged view top down.

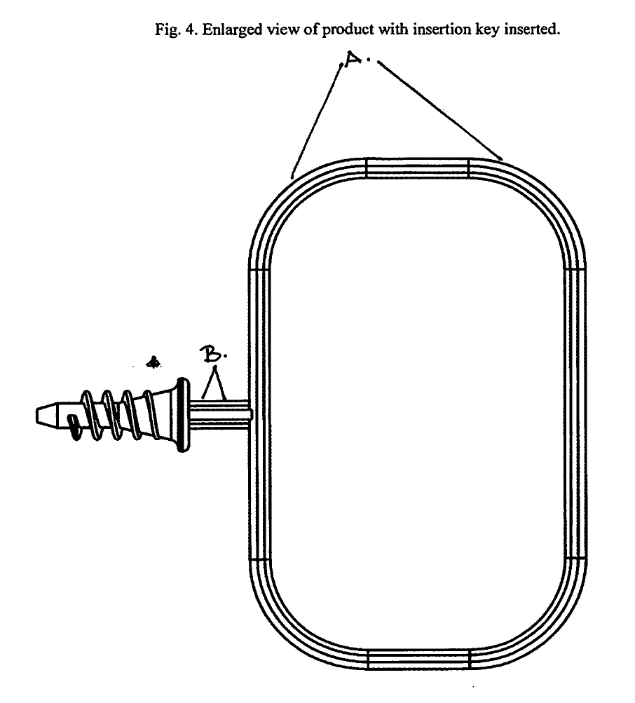

FIG. 4. Enlarged view of product with insertion key inserted.
A. Bow of key

B. Male key cuts

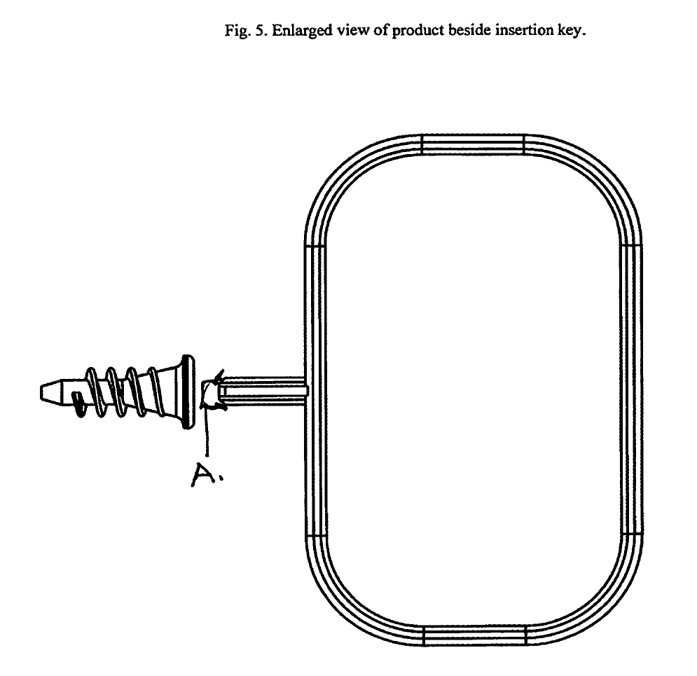

FIG. 5. Enlarged view of product prior to insertion key being inserted.

A. Tip of key

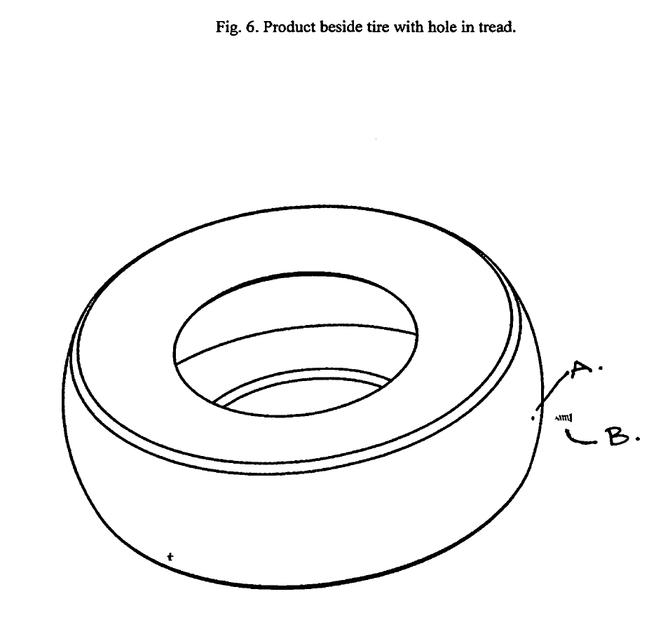

FIG. 6. Product beside tire with hole in tire tread.

A. Tire puncture

B. Screw

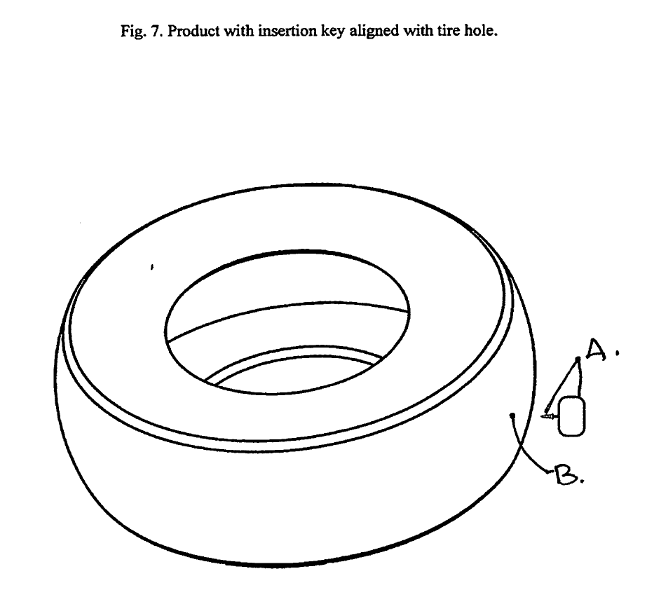

FIG. 7. Product with insertion key aligned with tire puncture hole.

A. Screw with key inserted, aligned with puncture hole

B. Tire puncture hole

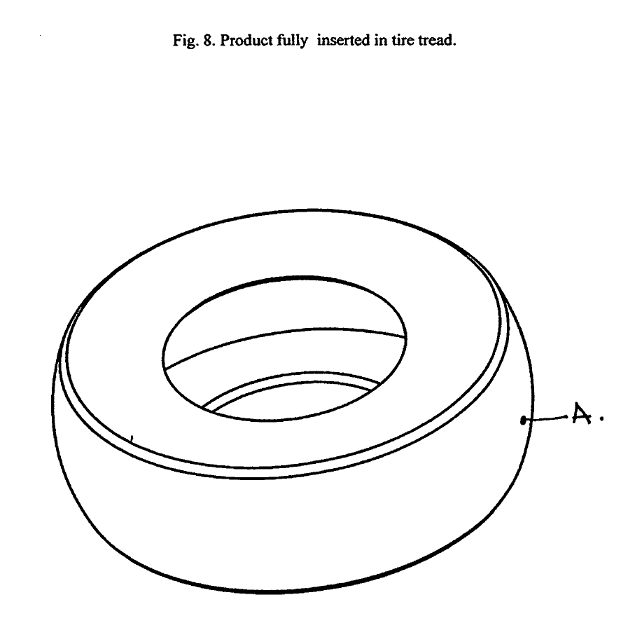

FIG. 8. Product fully inserted in tire tread

A. Head of screw fully inserted into tire puncture.

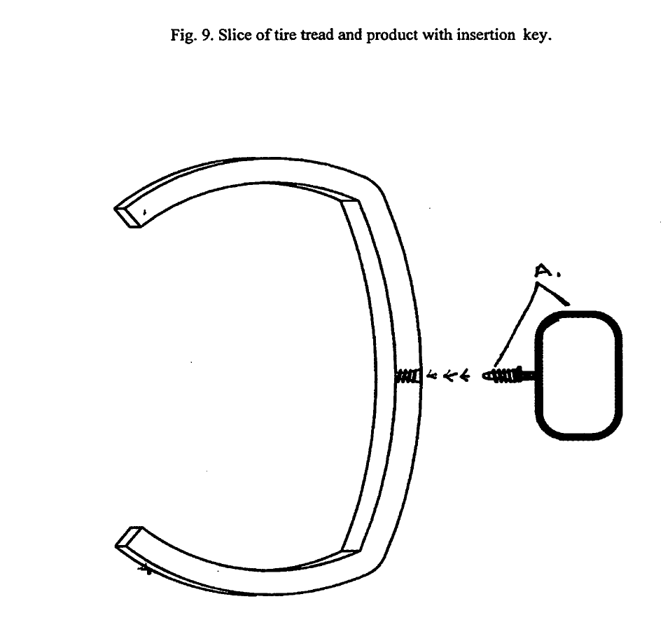

FIG. 9. Slice of tire tread and product with insertion key.

A. Screw aligned with tire puncture hole, prior to being driven in hole by key

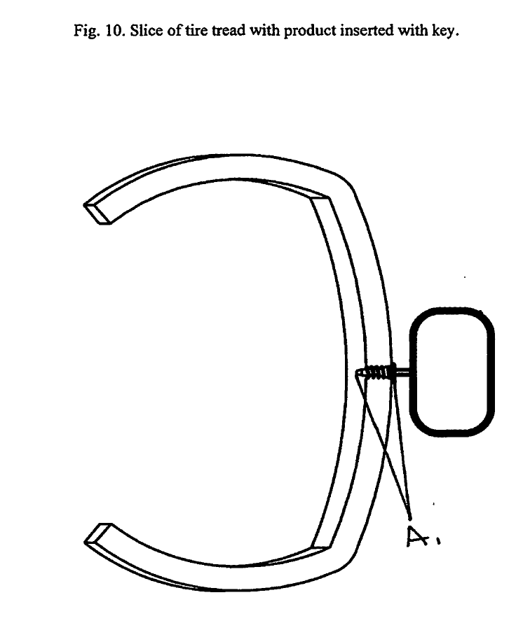

FIG. 10. Slice of tire tread with product fully immersed with key.

A. Screw fully inserted with key

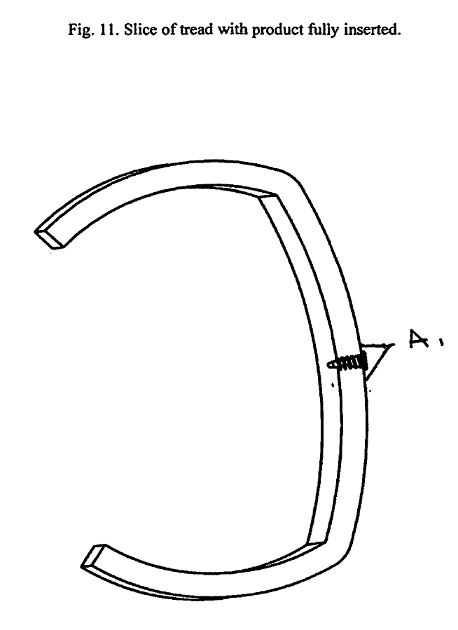

FIG. 11. Slice of tread with product fully inserted.

A. Product within tire puncture hole

### OATH OR DECLARATION

Additional PDF

### STATEMENT REGARDING FEDERALLY SPONSORED RESEARCH

n/a

1. A small vehicular tire tread puncture filling device comprising:
(a) Flat handled key's cuts are inserted into a flat top of core element, which has matching inverted area for key cuts to fit;
(b) Head of the core element's threaded shaft piece is lubricated, then twisted manually into vehicular tire tread puncture hole with flat handled key, until flat head of the threaded shaft piece is adjacent to tire tread;
(c) The flat handled key is removed from the head of core element; whereby a vehicular tire is ready to be re-inflated and driven on.
